(19) United States
(12) Patent Application Publication
(10) Pub. No.: US 2022/0105701 A1
(43) Pub. Date: Apr. 7, 2022

(54) CUSHIONING FLOORING UNDERLAYMENT

(71) Applicant: Zephyros, Inc., Romeo, MI (US)

(72) Inventors: Varun Mohan, Lexington, SC (US); Christophe Chaut, Molsheim (FR); Kendall Bush, Macomb, MI (US); Greg Thompson, Simpsonville, SC (US)

(73) Assignees: Zephyros, Inc., Romeo, MI (US); Pak-Lite, Inc., Suwanee, GA (US)

(21) Appl. No.: 17/429,670

(22) PCT Filed: Feb. 14, 2020
(86) PCT No.: PCT/US2020/018265

§ 371 Date: Aug. 10, 2021

Related U.S. Application Data
(60) Provisional application No. 62/805,538, filed on Feb. 14, 2019.

(51) Int. Cl. B32B 3/28; B32B 5/14; B32B 5/02; B32B 5/10; B32B 5/08

(52) U.S. Cl. CPC B32B 3/28; B32B 5/142; B32B 5/24; B32B 5/10; B32B 5/08; B32B 5/022

(57) ABSTRACT

A flooring underlayment including a multi-layer fibrous structure having one or more lapped layers; one or more facing layers; and a plurality of granules scattered on and/or embedded in one or more layers of the fibrous structure. The plurality of granules may be scattered on and/or embedded in at least one of the one or more lapped layers. The fibrous structure may include a granule support layer located beneath the plurality of granules. The granule support layer may be positioned on the lapped layer. The granules may be deposited on the granule support layer. The present teachings also include a flooring assembly including the fibrous structure and one or more flooring surfaces.

### FIELD

The present teachings relate generally to a flooring underlayment composite material and methods of forming the flooring underlayment composite material, in particular a composite material for use in architectural flooring applications.

### BACKGROUND

Common flooring systems include a subfloor of poured concrete or plywood and a finished floor, generally wood, tile, laminate, vinyl, and the like. Various assemblies are located between the subfloor and the finished floor to reduce sound transmission. Generally, these assemblies include the use of one or more of foams, glass fiber insulation, polymeric mats, liquid adhesives and/or solvents. Such assemblies can be time consuming and labor intensive to install. Some can also lead to undesirable added thickness. For these reasons, and others, industry is constantly seeking alternative flooring systems, or parts thereof, that provide damping and/or reduce audible noise from the floor.

In addition, there remains a need for flooring products that minimize flooring deformation, particularly after extended use. There remains a need for reducing fatigue stress and/or strain inside or beneath sheets, slabs, tiles, or planks. There remains a need for reducing tiles vibrating or noise radiating as a result of the vibration. There also remains a need for a flooring assembly, or parts thereof, that are able to stand up to the pressure of chairs, furniture, or other items that put consistent and/or concentrated pressure on the floor.

### SUMMARY

The present teachings meet one or more of the above needs by the improved article and methods described herein. The present teachings provide a fibrous structure or composite material for use as a flooring underlayment, where the combination of layers and materials thereof yield unique properties, such as improved below-room noise reduction, prevention of flooring cracking, or both, through a fiber-based solution employing granule additives.

The present teachings include a multi-layer fibrous structure. The fibrous structure may include one or more lapped layers; a facing layer; and a plurality of granules scattered on and/or embedded in one or more layers of the fibrous structure. The facing layer may be a flooring contact layer adapted to contact a flooring surface. At least one of the lapped layers may be a vertically lapped layer. The plurality of granules may be scattered on and/or embedded in at least one of the one or more lapped layers. The plurality of granules may be scattered on and/or embedded in one or more granule support layers. The granule support layer may be located below the plurality of granules. The granule support layer may be positioned on and/or adhered to a lapped layer.

A lapped layer may include elastomeric fibers and/or binders. These elastomeric fibers and/or binders may be present in an amount of about 20 percent by weight or greater, about 80 percent by weight or less, or both. The lapped layer may include one or more types of fibers having an increased surface area for contacting other fibers or one or more granules. The fibers having an increased surface area may include fibers having a multi-lobal cross-section, fibrillated fibers, or both. The granules of the fibrous structure may include an elastomeric material. The granules may be formed of a waste material (e.g., recycled shoes, tires, waste foams). The granules may include an expandable and/or heat activated material. One or more layers of the fibrous structure may be formed of spunbond (S) material, a spunbond and meltblown (SM) material, or a spunbond+meltblown+spunbond (SMS) nonwoven material. One or more layers of the fibrous structure may be a scrim. One or more layers of the fibrous structure may be formed by thermally skinning granules deposited on a surface of a layer (e.g., a lapped layer).

The present teachings also contemplate a flooring assembly including the fibrous structure and a flooring surface. Exemplary flooring surfaces include, but are not limited to, vinyl, luxury vinyl tile, laminate, type, wood planks, linoleum, engineered wood, cork, hardwood, bamboo, stone, or a combination thereof. The flooring assembly may be adapted to be installed on a subfloor (e.g., wood, concrete, cement, or the like).

### BRIEF DESCRIPTION OF THE DRAWINGS

FIG. 1 is an exemplary fibrous structure in accordance with the present teachings.

FIG. 2 is an exemplary fibrous structure and flooring assembly in accordance with the present teachings.

FIG. 3 is an exemplary fibrous structure in accordance with the present teachings.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the description herein, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The flooring assemblies and fibrous structures described herein may be located so that the layers provide sufficient acoustic damping. The assemblies may be provided as part of a subfloor, just below a finished floor, onto a subfloor or any combination of these. As described herein, subfloor may refer to materials such as wood, concrete, cement, or the like. The fibrous structure may be located below a flooring material. The flooring assemblies and/or fibrous structures may include any number of the layers described herein. Each layer may only be included once or may be included in multiple locations throughout the assembly. The assembly may include one or more adhesive layers. The flooring assembly and/or one or more fibrous structures may include one or more moisture impermeable layers so as to protect the fibrous material layer from moisture that commonly exists on subfloors (e.g., wood, concrete, cement, or the like).

The materials described herein may provide cushioning to a flooring assembly. The materials may function to reduce or prevent damage, such as cracking, to the flooring material. These materials may provide additional benefits such as compression resilience and puncture resistance, protection, padding, odor inhibition, cooling effects, insulative effects, fire retardance (e.g., to meet specific regulations, such as in residential or commercial construction, and/or for heated flooring), water repellency, breathability, or a combination thereof. The material may be shaped to fit the area to which it will be installed or used.

The materials provided herein may reduce audible noises and/or vibrations of elements within the flooring assembly. The flooring assembly as described herein includes a fibrous structure for achieving these benefits. The fibrous structure may include a plurality of layers, thereby forming a layered material. One or more layers may be flexible and/or provide softness. One or more layers may be rigid or provide strength to the fibrous structure.

The layered material may include one or more fibrous layers. While referred to herein for convenience as “layers,” it is contemplated that any discussion mentioning layers in the plural may also be referring to a singular layer. For example, it is contemplated that not all fibrous layers, should the fibrous structure include a plurality of fibrous layers, necessarily have the same properties, makeup, or structure. The fibrous layers may provide cushioning or protection. The fibrous layers may provide such cushioning or protection at a light weight. One or more of the fibrous layers may have a high loft (or thickness) at least in part due to the orientation of the fibers (e.g., oriented generally transverse to the longitudinal axis of the layer) of the layer and/or the methods of forming the layer. The fibrous layers may exhibit good resilience and/or compression resistance.

The fibrous layers may be adjusted based on the desired properties. The fibrous layers may be tuned to provide a desired weight, thickness, compression resistance, or other physical attributes. The fibrous layers may be formed from nonwoven fibers. The fibrous layers may be a nonwoven structure. The fibrous layers may be thermoformable so that the layers may be molded or otherwise manufactured into a desired shape to meet one or more application requirements. The fibrous layers may be a lofted material. The fibrous layers may be lapped layers (e.g., vertically lapped layers).

The tunable nature of the fibrous layers may be a result of the fibers used therein. The shape, size, type, diameter, modulus, stiffness, denier, crimp level, polymer properties, and the like, may impact performance of the material.

The fibers that make up the fibrous layers (or any other layer of the material) may have an average linear mass density of about 0.5 denier or greater, about 1 denier or greater, or about 5 denier or greater. The material fibers that make up the fibrous layers may have an average linear mass density of about 25 denier or less, about 20 denier or less, or about 15 denier or less. Fibers may be chosen based on considerations such as cost, resiliency, desired moisture absorption/resistance, or the like. For example, a coarser blend of fibers (e.g., a blend of fibers having an average denier of about 12 denier) may help provide resiliency to the fibrous layers. A finer blend (e.g., having a denier of about 10 denier or less or about 5 denier or less) may be used, for example, if a softer material is required. The fibers may have a staple length of about 1.5 millimeters or greater, or even about 70 millimeters or greater (e.g., for carded fibrous webs). For example, the length of the fibers may be between about 30 millimeters and about 65 millimeters. The fibers may have an average or common length of about 50 to 60 millimeters staple length, or any length typical of those used in fiber carding processes. Short fibers may be used (e.g., alone or in combination with other fibers) in any nonwoven processes. For example, some or all of the fibers may be a powder-like consistency (e.g., with a fiber length of about 3 millimeters or less, about 2 millimeters or less, or even smaller, such as about 200 microns or greater or about 500 microns or greater). Fibers of differing lengths may be combined to provide desired properties. The fiber length may vary depending on the application; the moisture properties desired; the type, dimensions and/or properties of the fibrous material (e.g., density, porosity, desired air flow resistance, thickness, size, shape, and the like of the fibrous layer and/or any other layers of the layered material); or any combination thereof. The addition of shorter fibers, alone or in combination with longer fibers, may provide for more effective packing of the fibers, which may allow pore size to be more readily controlled in order to achieve desirable characteristics (e.g., moisture interaction characteristics).

The fibrous layer may include a blend of fibers. The fibrous layer (or any other layer of the material) may include fibers blended with inorganic fibers. The fibrous layer may include natural, manufactured, synthetic fibers, or a combination thereof. Suitable natural fibers may include cotton, jute, wool, flax, silk, cellulose, glass, fibers derived from shells or husks (e.g., fruit and/or nut shells, such as coconut shells or fibers thereon, hazelnut shells, and the like), and ceramic fibers. The fibrous layer may include eco-fibers, such as bamboo fibers or eucalyptus fibers. Suitable manufactured fibers may include those formed from cellulose or protein. Suitable synthetic fibers may include polyester, polypropylene, polyethylene, Nylon, aramid, imide, acrylate fibers, or combination thereof. The fibrous layer material may comprise polyester fibers. The fibers may include polymeric fibers. The fibers may be selected for their melting and/or softening temperatures. The fibers may include mineral or ceramic fibers. The fibers may be or may include elastic or elastomeric fibers. These fibers may provide cushioning performance and/or compressibility and recovery properties. The fibers may provide fire or flame retardance. The fibers may be formed of any material that is capable of being carded and lapped into a three-dimensional structure. The fibers may be up to 100% virgin fibers. The fibers may be regenerated from postconsumer waste (for example, up to about 90% fibers regenerated from postconsumer waste or even up to 100% fibers regenerated from postconsumer waste).

The fibers may have or may provide improved thermal insulation properties. The fibers may have relatively low thermal conductivity. Such fibers may be useful for retaining heat or slowing the rate of heat transfer (e.g., to keep the floor warm). The fibers may have or may provide high thermal conductivity, thereby increasing the rate of heat transfer. Such fibers may be useful for extracting heat from the surface of the floor (e.g., to cool the floor). The fibrous layer may include or contain engineered aerogel structures to impart additional thermal insulating benefits. The fibrous layer may include or be enriched with pyrolized organic bamboo additives.

At least some of the fibers may be of an inorganic material. The inorganic material may be any material capable of withstanding temperatures of about 250° C. or greater, about 500° C. or greater, about 750° C. or greater, about 1000° C. or greater. The inorganic material may be a material capable of withstanding temperatures up to about 1200° C. (e.g., up to about 1150° C.). The fibers may include a combination of fibers having different melting points. For example, fibers having a melting temperature of about 900° C. may be combined with fibers having a higher melting temperature, such as about 1150° C. When these fibers are heated above the melting temperature of the lower melt temperature fibers (e.g exceeding 900° C.), the lower melt temperature fibers may melt and bind to the higher temperature fibers. The inorganic fibers may have a limiting oxygen index (LOI) via ASTM D2836 or ISO 4589-2 for example that is indicative of low flame or smoke. The LOI of the inorganic fibers may be higher than the LOI of standard binder fibers. For example, the LOI of standard PET bicomponent fibers may be about 20 to about 23. Therefore, the LOI of the inorganic fibers may be about 23 or greater. The inorganic fibers may have an LOI that is about 25 or greater. The inorganic fibers may be selected based on its desired stiffness. The inorganic fibers may be crimped or non-crimped. Non-crimped organic fibers may be used when a fiber with a larger bending modulus (or higher stiffness) is desired. The modulus of the inorganic fiber may determine the size of the loops when the matrix is formed. Where a fiber is needed to bend more easily, a crimped fiber may be used. The inorganic fibers may be ceramic fibers, silica-based fibers, glass fibers, mineral-based fibers, or a combination thereof. Ceramic and/or silica-based fibers may be formed from polysilicic acid (e.g., Sialoxol or Sialoxid), or derivatives of such. For example, the inorganic fibers may be based on an amorphous aluminum oxide containing polysilicic acid. The fibers may include about 99% or less, about 95% or less, or about 92% or less SiO₂. The remainder may include —OH (hydroxyl or hydroxy) and/or aluminum oxide groups. Siloxane, silane, and/or silanol may be added or reacted into the fiber injection molded portion to impart additional functionality. These modifiers could include carbon-containing components.

The fibers may have a cross-section that is substantially circular or rounded. The fibers may have a cross-section that has one or more curved portions. The fibers may have a cross-section that is generally oval or elliptical. The fibers may have a cross-section that is non-circular or non-cylindrical. Such non-circular cross-sections may provide for an increased surface area for the fiber, to provide more contact points between fibers, between fibers and binder, between fibers and granules, or a combination thereof. For example, the fibers may have geometries with a multi-lobal cross-section (e.g., having 3 lobes or more, having 4 lobes or more, or having 10 lobes or more). The fibers may have a cross-section with deep grooves. The fibers may have a substantially “Y”-shaped cross-section. The fibers may have a polygonal cross-section (e.g., triangular, square, rectangular, hexagonal, and the like). The fibers may have a star shaped cross-section. The fibers may be serrated. The fibers may have one or more branched structures extending therefrom. The fibers may be fibrillated. The fibers may have a cross-section that is a nonuniform shape, kidney bean shape, dog bone shape, freeform shape, organic shape, amorphous shape, or a combination thereof. The fibers may be substantially straight or linear, hooked, bent, irregularly shaped (e.g., no uniform shape), or a combination thereof. The fibers may have one or more crimps. Crimps may, for example, provide flexibility to the fiber, thereby allowing the fiber to undergo necessary shaping and/or processing. The fibers may include one or more voids extending through a length or thickness of the fibers. The fibers may have a substantially hollow shape. The fibers may include hollow conjugated fibers that are concentric, eccentric, or both. Such fibers may be used to tune the spring effect in the fiber, thereby altering resiliency of the three-dimensional structure. Such fibers may be present in an amount of about 5 percent by weight of the blend or greater, about 10 percent by weight of the blend or greater, or about 15 percent by weight of the blend or greater. The fibers may be generally solid.

The fibrous layer may include one or more elastomeric fiber materials. The elastomeric fiber materials may act as a binder. The elastomeric fiber materials may provide resilience to the fibrous layer. Exemplary elastomeric fibers include polyester materials, such as a high-performance polyester material. Such material may, for example, be available under the tradename ELK® available from Teijin frontier Co., Ltd. Exemplary elastomeric materials also include polyamide fibers and/or polyamide binders, alone or blended with other elastomeric fibers (e.g., blended with a high-performance polyester material). Further exemplary elastomeric fibers include elastic bicomponent PET, PBT, PTT, or a combination thereof. The fiber blend may include elastomeric fibers in an amount of about 20 percent by weight or greater, about 40 percent by weight or greater, or about 50 percent by weight or greater Elastomeric fibers may be present in the fiber blend in about 90 percent by weight or less, about 80 percent by weight or less, or about 70 percent by weight or less.

At least a portion of fibers making up the fibrous layers may have a low melt temperature. The amount of low melt temperature fibers may impact the strength of the layer. For example, improved performance of the fibrous layers and/or fibrous structure as a whole may he achieved by employing a fiber blend having low melt temperature fibers. Such performance may be measured using the Castor Chair Test, where results may be measured using ISO 4918:12016, for example. The fibers may have a melting point of about 70° C. or greater, about 100° C. or greater, about 110° C. or greater, about 130° C. or greater, 180° C. or greater, about 200° C. or greater, about 225° C. or greater, about 230° C. or greater, or even about 250° C. or greater.

One or more fibrous layers (or any other layer of the material) may include a plurality of bi-component fibers. The bi-component fibers may be a thermoplastic lower melt bi-component fiber. The bi-component fibers may have a lower melting temperature than the other fibers within the mixture (e.g., a lower melting temperature than common or staple fibers). The bi-component fibers may be air laid or mechanically carded, lapped, and fused in space as a network so that the layered material may have structure and body and can be handled, laminated, fabricated, installed as a cut or molded part, or the like to provide desired properties. The bi-component fibers may include a core material and a sheath material around the core material. The sheath material may have a lower melting point than the core material. The web of fibrous material may be formed, at least in part, by heating the material to a temperature to soften the sheath material of at least some of the bi-component fibers.

The fibrous layer (or any other layer of the layered material) may include a binder or binder fibers. Binder may be present in the fibrous layer in an amount of about 100 percent by weight or less, about 80 percent by weight or less, about 60 percent by weight or less, about 50 percent by weight or less, about 40 percent by weight or less, about 30 percent by weight or less, about 25 percent by weight or less, or about 15 percent by weight or less. The fibrous layer may be substantially free of binder. The fibrous layer may be entirely free of binder.

While referred to herein as fibers, it is also contemplated that the binder could be generally powder-like, spherical, or any shape capable of being received within interstitial spaces between other fibers and capable of binding the fibrous layer together. The binder may have a softening and/or melting temperature of about 70° C. or greater, about 100° C. or greater, about 110° C. or greater, about 130° C. or greater, 180° C. or greater, about 200° C. or greater, about 225° C. or greater, about 230° C. or greater, or even about 250° C. or greater. For example, the binder may have a softening and/or melting temperature between about 70° C. and about 250° C. (with any range therein being contemplated).

The fibers may be high-temperature thermoplastic materials. The fibers may include one or more of polyamideimide (PAI); high-performance polyimide (HPPA), such as Nylons; polyimide (PI); polyketone; polysulfone derivatives; polycyclohexane dimethyl-terephthalate (PCT); fluoropolymers; polyetherimide (PEI); polybenzimidazole (PBI); polyethylene terephthalate (PET); polybutylene terephthalate (PBT); co-polyester/polyester (CoPET/PET) adhesive bi-component fibers; polyphenylene sulfide; syndiotactic polystyrene; polyphenylene sulfide (PPS), polyether imide (PEI); and the like. The fibers may include polyacrylonitrile (PAN), oxidized polyacrylonitrile (Ox-PAN, OPAN, or PANOX), olefin, polyimide, polyetherketone (PEK), polyetheretherketone (PEEK), polyetherketoneketone (PEKK), polyethersulfone (PES), or other polymeric fibers. The fibrous layer may include polyacrylate and/or epoxy (e.g., thermoset and/or thermoplastic type) fibers. The fibrous layer may include a crystalline and/or amorphous binder polymer. Such polymer may affect energy dissipation properties, which may provide another degree of freedom for tuning the structure. Degree of crystallinity in the binder may affect resiliency and/or stiffness. This can be tuned this based on the type of binder selected, how the layer is heated and/or cooled during processing (e.g., during thermobonding), or both. The fibrous layer may include a multi-binder system. The fibrous layer may include one or more sacrificial binder materials and/or binder materials having a lower melting temperature than other fibers within the layer. The fibers may be selected for their melting and/or softening temperatures.

The fibers of the fibrous layer may be blended or otherwise combined with suitable additives such as other forms of recycled waste, virgin (non-recycled) materials, binders, fillers (e.g., mineral fillers), adhesives, powders, thermoset resins, coloring agents, flame retardants, longer staple fibers, etc., without limitation. Any, a portion, or all of the fibers used in the matrix could be of the low flame and/or smoke emitting type (e.g., for compliance with flame and smoke standards for transportation). Powders or liquids may be incorporated into the matrix that impart additional properties, such as binding, fire/smoke retarding intumescent, expanding polymers that work under heat, induction or radiation, which improves acoustic, physical, thermal, and fire properties. For example, active carbon powder may be incorporated into the fibrous layer, one or more nonwoven layers, or both.

The fibers and binders discussed herein in the context of the fibrous layers may also be used to form any other layer of the layered material.

The fibrous layers may include one or more lapped layers. A lapped layer may be formed by one or more lapping processes, including cross-lapping, vertical lapping, rotary lapping, the like, or a combination thereof. The lapped layer may have a fiber orientation that is generally vertical (e.g., oriented generally transverse to the longitudinal axis of the layer). The fibers may be a unique mixture of vertically or near-vertically oriented fibers. The fibers may be a unique mixture of fibers having a generally Z-shape, C-Shape, or S-shape, or other non-linear shape which may be formed by compressing fibers having a vertical or near-vertically orientation. The fibers may be in a three-dimensional loop structure. The loops may extend through the thickness direction from one surface of the matrix to an opposing surface of the matrix. The fibers may have an orientation within about ±60 degrees from vertical, about ±50 degrees from vertical, or about ±45 degrees from vertical. Vertical may be understood to be relative to a plane extending generally transverse from the longitudinal axis of the composite structure (e.g., in the thickness direction). Therefore, a vertical fiber orientation means that the fibers are generally perpendicular to the length of the composite structure (e.g., fibers extending in the thickness direction). It is also contemplated that fibers may be generally horizontally oriented (e.g., fibers extending in the length and/or width direction).

The fibers forming the one or more fibrous layers may be formed into a nonwoven web using nonwoven processes including, for example, blending fibers, carding, lapping, air laying, mechanical formation, or a combination thereof. Through these processes, the fibers may be oriented in a generally vertical direction or near-vertical direction (e.g., in a direction generally perpendicular to the longitudinal axis of the fibrous layer). The fibers may be opened and blended using conventional processes. The resulting structure formed may be a lofted fibrous layer. The lofted fibrous layer may be engineered for optimum weight, thickness, physical attributes, thermal conductivity, insulation properties, moisture absorption, or a combination thereof.

One or more fibrous layers may be formed, at least in part, through a carding process. The carding process may separate tufts of material into individual fibers. During the carding process, the fibers may be aligned in substantially parallel orientation with each other and a carding machine may be used to produce the web.

A carded web may undergo a lapping process to produce the fibrous layers. The carded web may be rotary lapped, cross-lapped or vertically lapped, to form a voluminous or lofted nonwoven material. The carded web may be vertically lapped according to processes such as “Struto” or “V-Lap”, for example. This construction provides a web with relative high structural integrity in the direction of the thickness of the fibrous layers, thereby minimizing the probability of the web falling apart during application, or in use, and/or providing compression resistance to the layered material. Carding and lapping processes may create nonwoven fibrous layers that have good compression resistance through the vertical cross-section (e.g., through the thickness of the layered material) and may enable the production of lower mass fibrous layers, especially with lofting to a higher thickness without adding significant amounts of fiber to the matrix. It is contemplated that hollow conjugate fiber may improve lofting capability and resiliency to improve physical integrity. Such an arrangement also provides the ability to achieve a low density web with a relatively low bulk density.

The lapping process may create a pleated or undulated appearance of the fibers when viewed from its cross-section. The frequency of the pleats or undulations may be varied during the lapping process. For example, having an increase in pleats or undulations per area may increase the density and/or stiffness of the layer or layers of the material. Reducing the pleats or undulations per area may increase the flexibility of the layer or layers and/or may decrease the density. The ability to vary the pleat or undulation frequency during the lapping process may allow for properties of the material to be varied or controlled. It is contemplated that the pleat or undulation frequency may be varied throughout the material. During the lapping process, the pleat frequency may be dynamically controlled and/or adjusted. The adjustment may be made during the lapping of a layer of the material. For example, certain portions of the layer may have an increased frequency, while other portions of the layer or layers may have a frequency that is lower. The adjustment may be made during the lapping of different layers of the material. Different layers may be made to have different properties with different pleat frequencies. For example, one layer may have a pleat frequency that is greater than or less than another layer of the layered material.

The fibrous layer or lapped layer may undergo additional processes during its formation. For example, during pleating of the matrix, it is contemplated that the lapped matrix can be in-situ horizontally needled with barbed pusher bar pins. Fibers of the fiber matrix (e.g., surface fibers) may be mechanically entangled to tie the fibers together. This may be performed by a rotary tool, with the top of the head having a grit-type finish to grab and twist or entangle the fibers as it spins. The fibers (e.g., the surface of the fibrous layer or lapped layer), then, can be entangled in the machine direction (e.g., across the tops of the peaks of the loops after lapping). It is contemplated that these rotating heads of the tool can move in both the x and y directions. The top surface of the fiber matrix, the bottom surface of the fiber matrix, or both surfaces may undergo the mechanical entanglement. The entanglement may occur simultaneously or at separate times. The process may be performed without binder, with minimal binder, or with a binder of about 40% by weight or less of the web content. The mechanical entanglement may serve to hold the fibrous layer or lapped layer together, for example, by tying the peaks of the three-dimensional loops together. This process may be performed without compressing the fiber matrix. The resulting surface of the fiber matrix may have improved tensile strength and stiffness of the vertical three-dimensional structure. The ability to tie the top surface to the bottom surface may be influenced by the fiber type and length, as well as the lapped structure having an integrated vertical three-dimensional loop structure from top to bottom. The mechanical entanglement process may also allow for mechanically tying fabrics or facings to the top and/or bottom surface of the lapped fiber matrix. The surface of the material may instead, or in addition to mechanical entanglement, be melted by an IR heating system, a hot air stream, or a laser beam, for example, to form a skin layer. Fibers, at the surface or within the layer, may be hydroentangled.

The fibrous structure may include granules or powder. For simplicity, the granules or powder will be referred to herein as granules. The granules may be scattered upon or embedded in one or more layers of the fibrous structure.

The granules may be selected to provide certain properties to the fibrous structure. The granules may provide or enhance a degree of structure-borne acoustic damping. The granules may improve sound transmission loss properties of the fibrous structure as compared to a structure without granules. The granules may provide or enhance resiliency of the fibrous structure and/or the layers containing the granules. The granules may provide strength to the fibrous structure and/or the layers containing the granules.

The fibrous structure may include one or more granule types. Granules may have elastic properties. Granules may have viscoelastic properties. Granules may impart resilience to the fibrous structure and/or layer where located. Granules may impart stiffness to the fibrous structure and/or layer where located. Granules may have expandable properties. Granules may be formed of an expandable polymeric material. Granules may be thermally activated. Granules may impart fire retardancy. For example, the granules may be activated upon exposure to high temperatures or flame. This may create a barrier to the flame. Granules may act as a binding agent with the fiber structure. Granules may have a low melting temperature so that the granule is caused to soften, melt, and/or flow to fill interstitial spaces in a layer. Granules may be a bi-component material, where one layer (e.g., the outer layer) softens, melts, flows, or expands up on application of a certain stimulus, such as heat. Granules, such as expandable granules, may be scattered and activated, such as during lamination or other situations where heat is applied, to fill gaps, bind fibers, act as a damper within one or more layers (e.g., within a fibrous or lapped layer), to build tortuosity, or a combination thereof. Granules may include any fibers or binders disclosed herein with respect to other layers of the fibrous structure. These fibers or binders may be further processed to obtain a desired particle size.

The granules may be formed by processing, chopping, grinding, or the like, fibers or other material to produce small particles of a desired size. The granules may be of a sufficient size that they are capable of filling interstitial spaces between fibers within a fibrous layer. The granules may be of a size that can be generally evenly distributed or scattered upon a surface of the fibrous structure (e.g., a granule support layer). In certain instances, the granules may be sufficiently large to avoid penetrating the entire thickness of a layer (e.g., a fibrous or lapped layer). The granules may have a particle diameter of about 0.025 mm or greater, about 0.04 mm or greater, or about 0.1 mm or greater. The granules may have a particle diameter of about 10 mm or less, about 5 mm or less, or about 1 mm or less. The particle size may depend upon where the granules are being positioned. For example, when embedding granules within a layer of the fibrous structure, the granules may be smaller (e.g., about 0.04 mm or greater, about 0.5 mm or less, or both). When melting granules to form a skin, the granules may be larger (e.g., about 0.5 mm or greater, about 5 mm or less, or both).

Granules may include a processed rubber powder. Granules may employ recycled or waste materials. For example, rubber or other elastomeric materials, such as those derived from shoes or shoe soles, tires, and the like, may be processed to produce small particles capable of being scattered. Processed or grinded materials from materials described herein may be used. For example, a lapped layer may be processed into granules. Granules may be formed from foams, such as waste foams. Granules may be formed from cork, epoxy, ethylene vinyl acetate (EVA), polyvinyl chloride (PVC), acrylic material, polyethylene, polypropylene, polystyrene, polyester, desiccants, odor scavenging materials (e.g., for moist or wet environments), synthetic beads, virgin pellets, microspheres (e.g., Expancel Microspheres), the like, or a combination thereof. An exemplary combination may be a triblock co-polymer having polystyrene end blocks and a vinyl bonded rich polydiene mid-block.

The granules may be scattered or otherwise deposited on or in one or more layers of the fibrous structure. The granules may be deposited by scatter coating or fibroline powder deposition technology, for example. The electrostatic charge of the granules may allow the granules to stick to the fibers until the binder is set. It is further contemplated that a flowable binder and/or bicomponent fiber may be used to bond granules to the fibrous structure.

The granules may be impregnated into the fibrous structure (e.g., in a fibrous layer, such as a lapped layer) in a controlled area. The granules may fill open areas in a fibrous layer. Filling these open areas may add rigidity to the layer. Rigidity may prevent floor cracking over time, which may result, for example, from flexing of the flooring material from repeated loading and/or unloading. The granules may be selected to still allow the fibrous structure or layer thereof to be sufficiently flexible to decouple the flooring from a concrete or wooden subfloor, for example.

The granules may be deposited on a surface of a layer of the fibrous structure. For example, granules may be scattered on a granule support layer. A granule support layer may, for example, be in planar contact with another layer of the fibrous structure, such as a fibrous or lapped layer.

The fibrous structure may include one or more additional layers (e.g., in addition to a fibrous layer and granules). The fibrous structure may include a plurality of layers, some or all of which serve different functions or provide different properties to the fibrous structure (when compared to other layers of the fibrous structure). The ability to combine layers and skins of materials having different properties may allow the fibrous structure to be customized based on the application. One or more additional layers within the fibrous structure may provide structural properties or may provide physical strength to the fibrous structure. One or more additional layers may repel water, moisture, fluids, and/or particles. A layer may be a permeable membrane to allow breathability while preventing fluid or moisture from seeping down into other layers of the fibrous structure, such as the fibrous layer. One or more layers may provide to encapsulate the system. One or more layers may have a damping effect. The layer may provide compression resistance, resilience, or both. The layer, or the fibrous structure as a whole, may provide insulative properties. The layer, or the fibrous structure as a whole, may be tuned to provide a desired thermal resistance. The layer, or the fibrous structure as a whole, may be tuned to provide a desired thermal conductivity. The layer, or the fibrous structure as a whole, may be tuned to provide desired properties, such as flame or fire retardance, smoke retardance, reduced toxicity, or the like. The layer may be able to withstand exposure to elevated temperatures.

These layers may include one or more of a facing layer, a backing layer, one or more intermediate layers, skin layers, or the like. A layer may be a flooring contact layer. A layer may be a granule support layer (e.g., for supporting the deposition or scattering of granules thereon). A facing layer or scrim may be applied to the fibrous or lapped layer. An additional functional layer may be applied to the fibrous structure or lapped layer. Another lapped layer or structure may be secured to a lapped layer. Another intermediate layer formed from any of the materials or structures described herein may be positioned between two lapped structures. Any combination of layers is contemplated herein.

The one or more additional layers may be formed of different materials. The one or more additional layers may be formed of the same materials. One or more additional layers may be formed from the fibers and/or binders as discussed herein with respect to the fibrous layer. The fibrous structure may include needlepunched layers, one or more spun-bond layers, one or more melt-blown layers, one or more spun-laced layers, one or more air-laid layers, or a combination thereof. A layer may be formed of spunbond (S) material, a spunbond and meltblown (SM) material, or a spunbond+meltblown+spunbond (SMS) nonwoven material. A layer may be spunlaced and/or hydroentangled. A layer may be a laminate. A layer may be a scrim. A layer may be a needlepunched layer, such as a needlepunched scrim. A layer may be a reinforcing mesh. A layer may be a mesh scrim (e.g., glass, metal, polymeric, such as PET, the like, or a combination thereof). A mesh scrim may be embedded within one or more other layers of the fibrous structure (e.g., embedded within a layer of granules). A layer may be a non-air flow resistive layer (e.g., a non-air flow resistive scrim). A layer may be a woven material, a nonwoven material, or both. A layer may be a felt material. A layer may be formed of a material that hardens or expands (e.g., upon activation) to provide stiffness or additional structural properties to the fibrous structure. The layer may be polymeric, where crystallinity can be adjusted to alter the structural properties of the fibrous structure. The crystallinity may be tuned, for example, during any heating and/or cooling process of the fibrous structure formation process. The layer may be formed of a polymeric, copolymeric, elastic, elastomeric, rubber, thermoplastic, thermosettable, or the like, material. The material may provide cushioning and/or resilience to the fibrous structure. The layer may include or may be formed from a powder. The powder may, for example, include ethylene vinyl acetate (EVA), ethylene propylene diene monomer (EPDM), or polyurethane (PUR). The layer may include or be formed from a thermoset curing powder, such as epoxy, which may be foamable, which may make the fibrous structure more rigid and/or resilient (e.g., as compared to a fibrous structure without such a layer).

A layer of the fibrous structure may have high infrared reflectance or low emissivity. At least a portion of layer may be metallized to provide infrared (IR) radiant heat reflection. The layer may be perforated. The layer may be permeable. The layer may be selectively permeable by design. The layer may be inherently permeable. To provide heat reflective properties to and/or protect other layers of the structure, the layer (e.g., fibers thereof, a surface of the layer, or the layer itself) may be metalized. For example, fibers may be aluminized. The fibers or layers themselves may be infrared reflective (e.g., so that an additional metallization or aluminization step may not be necessary). Metallization or aluminization processes can be performed by depositing metal atoms onto the fibers. As an example, aluminization may be established by applying a layer of aluminum atoms to the surface of fibers. Metalizing may be performed prior to the application of any additional layers to the fibrous web layer. It is contemplated that other layers of the fibrous structure may include metallized fibers in addition to, or instead of, having metallized fibers within the fibrous web layer.

A layer of the fibrous structure may be a conductive material. The layer may act to conduct heat and/or electricity. The layer may enable electromagnetic interference (EMI) attenuation. The layer may be formed form EMI shielding materials. The layer may be a metallic material or include a metallic material. For example, the layer may be or may include silver, gold, or copper or may be coated with such material.

Where the layer may be exposed to high temperatures, the layer may include solid films, perforated films, solid foils, perforated foils, woven or nonwoven scrims, selectively permeable films or foils, or other materials. A layer may be formed from polybutylene terephthalate (PBT); polyethylene terephthalate (PET), polypropylene (PP), cellulosic materials, or a combination thereof. A layer may be formed from nonwoven material, woven material, or a combination thereof. A layer may include polysilicic acid fibers, minerals, ceramic, fiberglass. or aramids. Films may include polyetheretherketone (PEEK), polyethersulfone (PES), polyetherketone (PEK), urethane, polyimide, or a combination thereof. The layer may be metallized to impart infrared reflectivity, thus providing an improved thermal insulating value to the overall fibrous structure. Any of the layers may have a thermal resistance capable of withstanding the temperatures to which the layers will be exposed. These materials, however, are not limited to use in high temperature applications. It is contemplated that such materials may also be used for facing layers of the fibrous structure, for example.

A layer of the fibrous structure may be formed from or include an activatable or reactive material. The layer may be or may include an intumescent. A layer may include an expandable material. The expandable material may be any suitable polymeric material capable of expansion and adhesively bonding to a substrate upon curing. Illustrative materials are described in U.S. Pat. Nos. 5,884,960; 6,348,513; 6,368,438; 6,811,864; 7,125,461; 7,249,415; published U.S. Application No. 20040076831, incorporated by reference. The layer may provide for latent reaction or activation. The layer may be formed from any type of reactive film or nonwoven to capture or scavenge chemicals or molecules from air or liquids. The layer may be a nanofiber type nonwoven that can be chemically altered to have such functionality.

A layer may be capable of providing other benefits, such as odor control and/or antimicrobial properties. For example, the layer may be an active carbon film or other nonwoven layer. The layer may include or be treated with copper, steel (e.g., stainless steel), silver, or other metallic materials. Other layers of the fibrous structure (e.g., carded layers) may include these components for achieving odor control and/or antimicrobial properties.

One or more additional layers may be generally hydrophobic. One or more additional layers may be generally hydrophilic. A corrosion resistant coating may be applied to reduce or protect metal (e.g., aluminum) from oxidizing and/or losing reflectivity. IR reflective coatings not based on metallization technology may be added. One or more coatings may be applied to the fibers forming the additional layer, or to the surface of the layer itself. Oleophobic and/or hydrophobic treatments may be added. Flame retardants may be added. One or more additional layers may be porous or perforated. One or more layers may be permeable or at least partially permeable. One or more additional layers may be solid (e.g., non-porous or non-perforated). One or more additional layers may be generally flexible. One or more additional layers may be generally rigid.

As an example, the fibrous structure may include one or more facing layers. The facing layer may be an outermost layer of the fibrous structure. The facing layer may be adapted to be in planar contact with the underside of a flooring layer. Therefore, the facing layer may act as a flooring contact layer.

The fibrous structure may include a backing layer. While referred to herein as a backing layer, it may be considered another facing layer. The backing layer may be the undermost layer of the fibrous structure. The backing layer may be adapted to be in planar contact with the subfloor or cement to which the fibrous structure is to be positioned. It is also contemplated that the fibrous structure is free of a backing layer.

One or more intermediate layers may be located between a facing layer or flooring contact layer and the fibrous layer. For example, a granule support layer may be in contact with a surface of the fibrous layer. Granules may be deposited thereon or therein. A granule support layer may contain the granules within the fibrous structure. A facing layer may be positioned over the granules and granule support layer. A granule support layer may be positioned on an opposing side of a fibrous layer from the facing layer.

One or more skin layers may be formed within the fibrous structure. The skin layer may be formed on the surface of a layer of the fibrous structure. The skin layer may be formed as an in-situ process by applying heat at or near the surface of layer where a skin is desired. For example, granules may be scattered on a fibrous or lapped layer or a granule support layer. As the heat is applied, the granules localized near the surface may soften and/or melt. The softened granule material may flow through the matrix of fibers or any interstitial spaces between fibers of the layer beneath. The softened granules may act to plug the free volume space surrounding the granules, particularly at the surface of the material. The softened granules may then densify to create the resulting skin layer. The skin layer may be formed by softening and/or melting fibers or binder of one or more layers of the fibrous structure (e.g., instead of or in addition to melting granules of the fibrous structure). The resulting skin layer may be a smooth layer of material that provides some structural characteristics (e.g., stiffness, compression resilience) to the fibrous structure. The resulting skin layer may create an aesthetically pleasing look to the material. The smooth layer may also be used as a foundation for supporting other materials and/or for adhering other materials thereto to provide additional properties. The skin layer may assist in preventing fraying or unraveling of the fibrous structure. The skin layer may be preferred over a facing layer, as it is not a separately attached layer, thereby reducing the likelihood of the layers coming apart. The skin layer may serve as a surface for supporting a facing layer. The method of skinning may be performed using a laminator. The method may be performed, for example, through conductive heat transfer and pressure via a calender, a flat bed or heated pinch roll lamination process to form the skin layer.

While any configuration of layers is possible, an exemplary configuration includes a lapped layer having a facing layer on one surface and a backing layer or granule deposition layer on the opposing surface. Granules may be encapsulated within the lapped layer. Another exemplary configuration includes a lapped layer with a granule support layer situation thereon. Granules are deposited on the granule support layer. A facing layer may be applied upon the granules and granule support layer. Another exemplary configuration includes forming a skin layer via a layer of granules deposited on a surface of another layer (e.g., a lapped layer). A mesh scrim, such as a glass or PET mesh scrim, may be positioned within the fibrous layer. The mesh scrim may be laid on the lapped layer before or after scattering the granules. After heating and/or lamination, the mesh would be embedded within the granules and/or fibrous structure. Such mesh could provide increased stability, compression resistance, strength, stiffness, product lifetime, the like, or a combination thereof.

The fibrous structure layers may be bonded together to create the finished fibrous structure. One or more layers may be bonded together by elements present in the layers. For example, the binder fibers in the layers may serve to bond the layers together. The outer layers (i.e., the sheath) of bi-component fibers in one or more layers may soften and/or melt upon the application of heat, which may cause the fibers of the individual layers to adhere to each other and/or to adhere to the fibers of other layers. Layers (e.g., skin layers) may be formed by one or more lamination processes. Other layers (e.g., a nonwoven lofted layer or skin layer to another nonwoven lofted layer or skin layer) may be joined through one or more lamination processes. One or more adhesives may be used to join two or more layers. The adhesives may be a powder or may be applied in strips, sheets, or as a liquid, for example. It is possible that the adhesive does not block the air flow through the material (e.g., does not plug openings, perforations, pores, or the like).

The fibrous structure, or parts thereof, may be formed or assembled using a lamination process. For example, the fibrous structure may be constructed by carding and lapping one or more thicker nonwoven layers and applying heat via lamination to form the skin layer on the surface of the nonwoven layers. Lamination may be performed to compress one or more layers (e.g., one or more lapped layers). The layers may be laminated to another layer within the nonwoven production and laminating process, or as separate processes. Additional layers can be laminated in the same way.

An adhesive may be located on or between any layers of the fibrous structure. The adhesive may allow for adhering the fibrous structure to a desired substrate (e.g., a flooring surface, a subfloor or cement floor, or both). The fibrous structure may be provided with a pressure sensitive adhesive (PSA). The PSA may be applied from a roll and laminated to a surface of the fibrous structure. A release liner may carry the PSA. Prior to installation of the fibrous structure, the release liner may be removed from the pressure sensitive adhesive to allow the fibrous structure to be adhered to a substrate or surface. For some applications, it may be beneficial to provide a release liner with a high tear strength that is easy to remove.

The PSA may be provided as part of a tape material comprising: a thin flexible substrate; a PSA substance carried on a single side of the substrate, the PSA substance being provided along a length of the substrate (e.g., in an intermittent pattern or as a complete layer); and optionally a mesh carried on the single side. The PSA may be coated onto a silicone coated plastic or paper release liner. The PSA may be of the supported design, where the PSA layer may be bonded to a carrier film, and the carrier film may be bonded to the fibrous composite layer. A thin flexible substrate may be located on the side of the PSA layer opposite the carrier film. The end user may then remove the thin flexible substrate (e.g., release liner) to install the part to the target surface. The supported construction may be up to 100% coverage, or the PSA may be supplied in an intermittent pattern. The supported construction may include embedded mesh.

The purpose of the substrate of the tape material is to act as a carrier for the PSA substance so that the PSA substance can be applied (adhered) to the sound absorbing material. The substrate further acts as the release liner and can be subsequently removed by peeling it away, leaving the PSA substance exposed on the side where the substrate used to be. The newly exposed face of the PSA substance can be applied to a target surface, for example such as a panel or surface, to adhere the composite sound absorber to the target surface.

The entire side (e.g., about 100%) of a surface of the fibrous structure may be coated with the PSA. If provided in an intermittent PSA coating, depending on the size and spacing of the applied portions of the intermittent PSA coating, the percentage of coated area can be varied. The applied area of the coating can vary between about 10 and about 90%, or more specifically about 30% to about 40%, of the area of the substrate, for example.

The intermittent coating may be applied in strips or in another pattern. This can be achieved by hot-melt coating with a slot die, for example, although it can also be achieved by coating with a patterned roller or a series of solenoid activated narrow slot coating heads, for example, and may also include water and solvent based coatings, in addition to hot-melt coating.

Where the PSA coating is applied in strips, the spacing of the strips may vary depending on the properties of the acoustic material. For example, a lighter acoustic material may need less PSA to hold the material in place. A wider spacing or gap between the strips can facilitate easier removal of the substrate, as a person can more readily find uncoated sections that allow an edge of the substrate to be lifted easily when it is to be peeled away to adhere the sound absorbing material to another surface.

By applying the adhesive in an intermittent pattern, such as longitudinal strips, it is possible to still achieve the coating weight desired for a particular application, while saving a large percentage of the PSA resin by coating only some portions of the total area. Thus, it may be possible to use a reduced amount of PSA substance because the sound absorbing material of certain embodiments is a lightweight and porous article that does not require an all-over coating. Lowering the overall amount of PSA used also has the effect of minimizing the toxic emissions and volatile organic compounds (VOC) contributed by the PSA substance used to adhere the sound absorbing material to a target surface. The described acrylic resin used for the PSA also has relatively low VOC content.

The pressure sensitive adhesive substance may be an acrylic resin that is curable under ultraviolet light, such as AcResin type DS3583 available from BASF of Germany. A PSA substance may be applied to substrate in a thickness of about 10 to about 150 microns, for example. The thickness may alternatively be from about 20 to about 100 microns, and possibly from about 30 to about 75 microns, for example.

Other types of PSA substance and application patterns and thicknesses may be used, as well as PSA substances that can be cured under different conditions, whether as a result of irradiation or another curing method. For example, the PSA substance may comprise a hot-melt synthetic rubber-based adhesive or a UV-curing synthetic rubber-based adhesive.

In addition to or instead of using an adhesive to adhere the fibrous structure within an assembly, it is contemplated that one or more layers of the fibrous structure may have a tacky surface or semi-tacky or a high friction surface. This may reduce slipping or shifting of the fibrous structure during installation and use. This tackiness or high-friction surface may be from a coating applied to the material. This tackiness or high-friction surface may be inherent in the material of the layer contacting another surface or substrate within the assembly (e.g., a flooring surface, a subfloor or cement slab, or a combination thereof).

Acoustic properties of the fibrous structure (and/or its layers) may be impacted by the shape of the fibrous structure. The fibrous composite, or one or more of its layers, may be generally flat. The finished fibrous composite may be fabricated into cut-to-print two-dimensional flat parts for installation into the end user, installer, or customer's assembly. The fibrous structure may be formed into any shape. For example, the fibrous structure may be molded (e.g., into a three-dimensional shape) to generally match the shape of the area to which it will be installed. The finished fibrous composite may be molded-to-print into a three-dimensional shape for installation into the end user, installer, or customer's assembly. The three-dimensional geometry of a molded product may provide additional acoustic absorption. The three-dimensional shape may provide structural rigidity and an air space.

The present teachings also include a flooring assembly. The flooring assembly may include a fibrous structure and one or more flooring surfaces. Exemplary flooring surfaces include vinyl, luxury vinyl tile, laminate, tile, wood planks, linoleum, engineered wood, cork, hardwood, bamboo, and stone. The flooring assembly may therefore include a fibrous structure positioned on a subfloor or cement slab. The flooring surface may then be positioned on the fibrous structure.

The fibrous structure as described herein acts to decouple the flooring from a concrete or cement slab or wooden subfloor to provide superior noise reduction. The fibrous structure may also provide one or more modes of mechanical energy dissipation. For example, energy dissipation may be achieved through fiber-to-fiber contact, granule-to-fiber contact, and granule-to-granule contact.

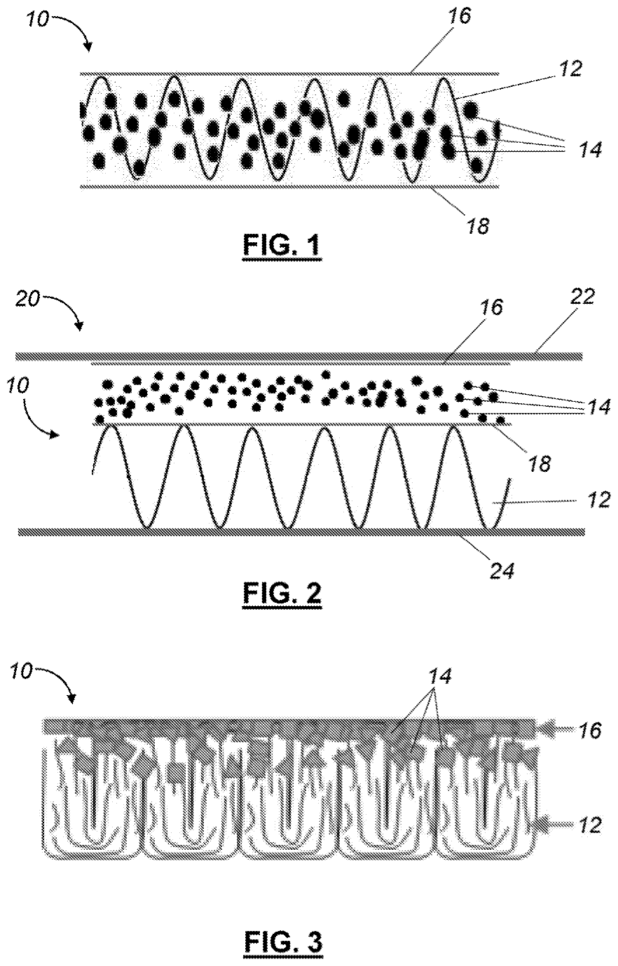

Turning now to the figures, FIG. 1 is an exemplary fibrous structure 10. As shown, the fibrous structure 10 includes a lapped layer 12. A plurality of granules 14 are scattered within the lapped layer 12. A facing layer 16 is located on one side of the lapped layer 12. The facing layer may serve as a flooring contact layer, thereby making contact with a flooring surface when installed. A granule support layer 18 is located on the opposing side of the lapped layer 12, here serving as a backing layer while also ensuring the granules are contained within the lapped layer. The granule support layer 18 may be adapted to contact a subfloor or cement when installed.

FIG. 2 is an exemplary fibrous structure 10 as part of a flooring assembly 20. The fibrous structure 10 includes a lapped layer 12, which supports a facing layer 16, a plurality of granules 14, and a granule support layer 18. The facing layer 16 as shown herein makes planar contact with the underside of a flooring surface 22. Between the facing layer 16 and the granule support layer 18 are a plurality of granules 14. The granule support layer 18 acts as a surface upon which the granules 14 are deposited. The lapped layer 12, on the opposing side, rests upon a subfloor or cement 24 of the flooring assembly 20.

The facing layer and the granule support layer as shown in the figures may be formed of the same materials or different.

FIG. 3 is an exemplary fibrous structure 10, which includes a lapped layer 12. A facing layer 16 is located at the surface of the lapped layer 12 and is shown here as a skin layer formed from a plurality of granules 14 (e.g., where heat has been applied to the surface of the granules to form a thermally skinned surface). When the granules 14 are scattered on the surface of the lapped layer 12, the particle size may prevent the granules from penetrating completely through the lapped layer 12.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the of a range in terms of “at least ‘x’ parts by weight of the resulting composition” also contemplates a teaching of ranges of same recited amount of “x” in percent by weight of the resulting composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist of, or consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

1. A multi-layer fibrous structure comprising:
a. one or more lapped layers;
b. one or more facing layers; and
c. a plurality of granules scattered on and/or embedded in one or more of the lapped layers of the fibrous structure and/or embedded in one or more of the facing layers
wherein the fibrous structure is a flooring underlayment.

2. The fibrous structure of claim 1, wherein the plurality of granules are scattered on and/or embedded in at least one of the one or more lapped layers.

3. The fibrous structure of claim 1, wherein at least one of the one or more lapped layers is a vertically lapped layer.

4. The fibrous structure of claim 1, wherein the facing layer is a flooring contact layer adapted to contact a flooring surface, a subfloor, and/or both.

5. The fibrous structure of claim 1, wherein the fibrous structure comprises a granule support layer attached to one of the one or more lapped layers and located beneath the plurality of granules.

6. The fibrous structure of claim 5, wherein the granules are deposited on the granule support layer.

7. The fibrous structure of claim 1, wherein at least one of the one or more lapped layers comprises elastomeric fibers and/or binders.

8. The fibrous structure of claim 7, wherein the elastomeric fibers and/or binders are present in an amount of about 20 percent by weight or greater and about 80 percent by weight or less.

9. (canceled)

10. The fibrous structure of claim 1, wherein the lapped layer includes one or more types of fibers having an increased surface area for contacting other fibers or one or more granules.

11. (canceled)

12. The fibrous structure of claim 1, wherein the granules comprise an elastomeric material.

13. The fibrous structure of claim 1, wherein the granules are formed of waste materials.

14. The fibrous structure of claim 1, wherein the granules comprise processed rubber powder.

15. The fibrous structure of claim 1, wherein the granules comprise an expandable and/or heat activated material.

16. The fibrous structure of claim 1, wherein one or more layers of the fibrous structure is formed of spunbond (S) material, a spunbond and meltblown (SM) material, or a spunbond+meltblown+spunbond (SMS) nonwoven material.

17. The fibrous structure of claim 1, wherein one or more layers of the fibrous structure is a scrim or reinforcing mesh.

18. The fibrous structure of claim 1, wherein one or more layers of the fibrous structure is formed from thermally skinning fibers and/or granules deposited on a surface of the lapped layer.

19. A flooring assembly comprising a flooring surface and the fibrous structure of claim 1.

20. The flooring assembly of claim 19, wherein the flooring surface is vinyl, luxury vinyl tile, laminate, type, wood planks, linoleum, engineered wood, cork, hardwood, bamboo, stone, or a combination thereof.

21. The flooring assembly of claim 19, wherein the flooring assembly is adapted to be installed on a subfloor.

22. The flooring assembly of claim 19, wherein the flooring assembly includes one or more pressure sensitive adhesive layers for bonding the flooring surface to the fibrous structure, bonding the fibrous structure to a subfloor, or both.
